(19) United States
(12) Patent Application Publication
(10) Pub. No.: US 2022/0128664 A1
(43) Pub. Date: Apr. 28, 2022

(54) LASER RADAR

(71) Applicant: Panasonic Intellectual Property Management Co., Ltd., Osaka (JP)

(72) Inventors: Yasuyuki KANO, Osaka (JP); Tetsuhisa HOSOKAWA, Osaka (JP); Ryo FUKUDA, Osaka (JP)

(21) Appl. No.: 17/570,795

(22) Filed: Jan. 7, 2022

Related U.S. Application Data
(63) Continuation of application No. PCT/JP2020/021728, filed on Jun. 2, 2020.

(30) Foreign Application Priority Data
Jul. 26, 2019 (JP) 2019-137672

(51) Int. Cl. G01S 7/481; G02B 27/30; G02B 19/00

(52) U.S. Cl. CPC G01S 7/4815; G02B 27/30; G02B 19/0076; G02B 19/0009; G01S 7/4813

(57) ABSTRACT

A laser radar includes: a base member; a drive part configured to rotate the base member about a rotation axis; and a plurality of optical units arranged on the base member at a predetermined interval in a circumferential direction about the rotation axis and each configured to project laser light in a direction away from the rotation axis. Here, projection directions of the laser lights from the plurality of optical units are different from each other in a direction parallel to the rotation axis.

### CROSS REFERENCE TO RELATED APPLICATION

This application is a continuation of International Application No. PCT/JP2020/021728 filed on Jun. 2, 2020, entitled “LASER RADAR”, which claims priority under 35 U.S.C. Section 119 of Japanese Patent Application No. 2019-137672 filed on Jul. 26, 2019, entitled “LASER RADAR”. The disclosure of the above applications is incorporated herein by reference.

### BACKGROUND OF THE INVENTION

### 1. Field of the Invention

The present invention relates to a laser radar for detecting an object by using laser light.

### 2. Disclosure of Related Art

In recent years, a laser radar has been used for the security purpose of detecting intrusion into a building, etc. Generally, the laser radar scans a target region with laser light, and detects the presence/absence of an object at each scanning position on the basis of reflected light at each scanning position. In addition, the laser radar detects the distance to the object at each scanning position on the basis of the time taken from the irradiation timing of the laser light to the reception timing of the reflected light at each scanning position.

Japanese Patent No. 6069281 describes a detection device including a stationary pedestal and a scanning part which rotates about a rotation axis with respect to the pedestal, and states that a plurality of detection units are housed in the scanning part in the circumferential direction about the rotation axis and rotate together with the scanning part, and an object is detected, for example, by using laser light.

In the above-described detection device, a range in the circumferential direction about the rotation axis is scanned by the detection units rotating about the rotation axis. However, there is a limit to expanding the laser light with a single lens, so that it is difficult to expand the scanning range in a direction parallel to the rotation axis.

### SUMMARY OF THE INVENTION

A laser radar according to a first aspect of the present invention includes: a base member; a drive part configured to rotate the base member about a rotation axis; and a plurality of optical units arranged on the base member at a predetermined interval in a circumferential direction about the rotation axis and each configured to project laser light in a direction away from the rotation axis. Projection directions of the laser lights from the plurality of optical units are different from each other in a direction parallel to the rotation axis.

With the laser radar according to this aspect, when the base member rotates about the rotation axis, a range in the circumferential direction centered on the rotation axis is scanned with the laser light emitted from each optical unit. At this time, since the projection directions of the laser lights from the respective optical units are different from each other in the direction parallel to the rotation axis, the ranges scanned with the respective laser lights are shifted from each other in the direction parallel to the rotation axis. Therefore, the entire range scanned with these laser lights is a wide range obtained by integrating the scanning ranges of the respective laser lights shifted from each other in the direction parallel to the rotation axis. Therefore, the scanning range in the direction parallel to the rotation axis can be effectively expanded.

A laser radar according to a second aspect of the present invention includes: a base member; a drive part configured to rotate the base member about a rotation axis; and a plurality of optical units arranged on the base member at a predetermined interval in a circumferential direction about the rotation axis and each configured to project laser light in a direction away from the rotation axis. Projection directions of the laser lights from the plurality of optical units are the same in a direction parallel to the rotation axis.

With the laser radar according to this aspect, the projection directions of the laser lights from the respective optical units are the same in the direction parallel to the rotation axis. Accordingly, the detection frequency for a range around the rotation axis can be increased, so that a high frame rate can be achieved without increasing the rotation speed.

### BRIEF DESCRIPTION OF THE DRAWINGS

FIG. 1 is a perspective view for illustrating assembly of a laser radar according to an embodiment;

FIG. 2 is a perspective view showing a configuration of the laser radar in a state where assembly of a portion excluding a cover according to the embodiment is completed;

FIG. 3 is a perspective view showing a configuration of the laser radar according to the embodiment in a state where the cover is attached;

FIG. 4 is a cross-sectional view showing a configuration of the laser radar according to the embodiment;

FIG. 5A is a perspective view showing a configuration of an optical system of an optical unit according to the embodiment;

FIG. 5B is a side view showing the configuration of the optical system of the optical unit according to the embodiment;

FIG. 5C is a schematic diagram showing a configuration of sensors of a photodetector according to the embodiment;

FIG. 6A is a top view of the laser radar according to the embodiment as viewed in a Z-axis negative direction;

FIG. 6B is a schematic diagram showing a projection angle of projection light of each optical unit according to the embodiment when each optical unit is positioned on an X-axis positive side of a rotation axis;

FIG. 7 is a circuit block diagram showing the configuration of the laser radar according to the embodiment;

FIG. 8A is a schematic diagram for illustrating a light emission angle interval and a light emission time interval according to a comparative example;

FIG. 8B is a schematic diagram showing light emission timings of six optical units in response to the passage of time according to the comparative example;

FIG. 9A to FIG. 9F are diagrams showing positions (angles) at which the six optical units emit light according to the comparative example;

FIG. 10 is a diagram showing positions (angles) at which each optical unit according to the comparative example emits light until the six optical units rotate 360°;

FIG. 11 is a schematic diagram showing the arrangement of optical units when a laser radar according to a modification is viewed in a Z-axis negative direction;

FIG. 12A to FIG. 12F are diagrams showing positions (angles) at which six optical units according to the modification emit light;

FIG. 13 is a diagram showing positions (angles) at which each optical unit according to the modification emits light until the six optical units rotate 360°;

FIG. 14A is a schematic diagram showing six light fluxes according to another modification;

FIG. 14B is a schematic diagram showing a configuration of a photodetector according to the other modification;

FIG. 14C is a schematic diagram showing six light fluxes according to another modification;

FIG. 14D is a schematic diagram showing a configuration of a photodetector according to the other modification;

FIG. 15A is a schematic diagram showing a configuration of a projection optical system of an optical unit according to another modification;

FIG. 15B is a schematic diagram showing six diffracted light beams according to the other modification;

FIG. 15C is a schematic diagram showing a configuration of the photodetector according to the other modification;

FIG. 16A and FIG. 16C are schematic diagrams each showing the six diffracted light beams according to another modification;

FIG. 16B and FIG. 16D are schematic diagrams each showing a configuration of the photodetector according the other modification;

FIG. 17A is a schematic diagram showing a configuration of the laser radar according to another modification in which twelve optical units are installed;

FIG. 17B is a schematic diagram showing a configuration of the laser radar according to the other modification in which eight optical units are not arranged at equal intervals; and

FIG. 18 is a cross-sectional view showing a configuration of the laser radar according to another modification.

It should be noted that the drawings are solely for description and do not limit the scope of the present invention by any degree.

### DESCRIPTION OF PREFERRED EMBODIMENTS

Hereinafter, an embodiment of the present invention will be described with reference to the drawings. For convenience, in each drawing, X, Y, and Z axes that are orthogonal to each other are additionally shown. The Z-axis positive direction is the height direction of a laser radar 1.

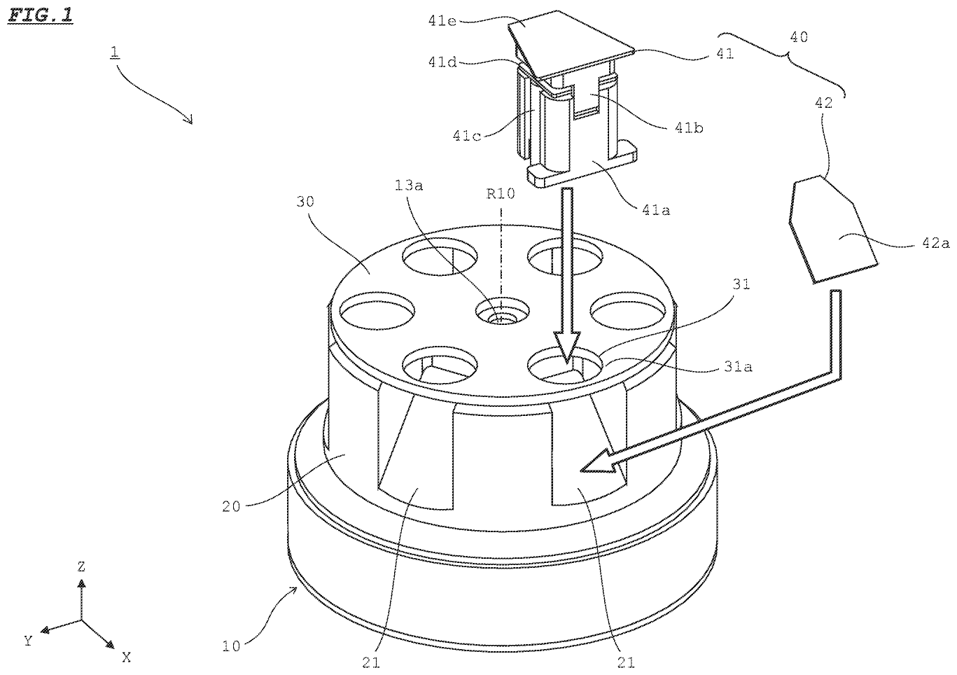

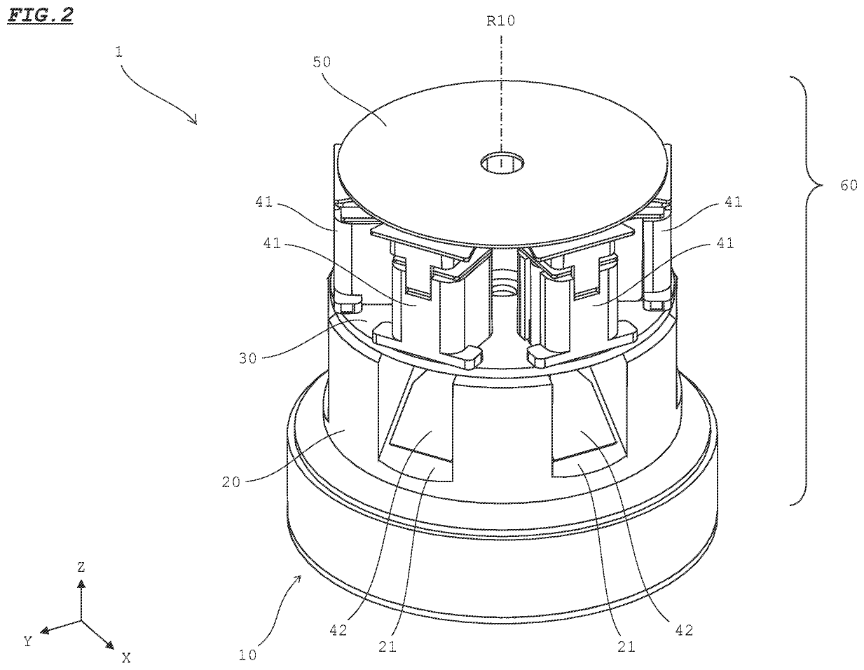

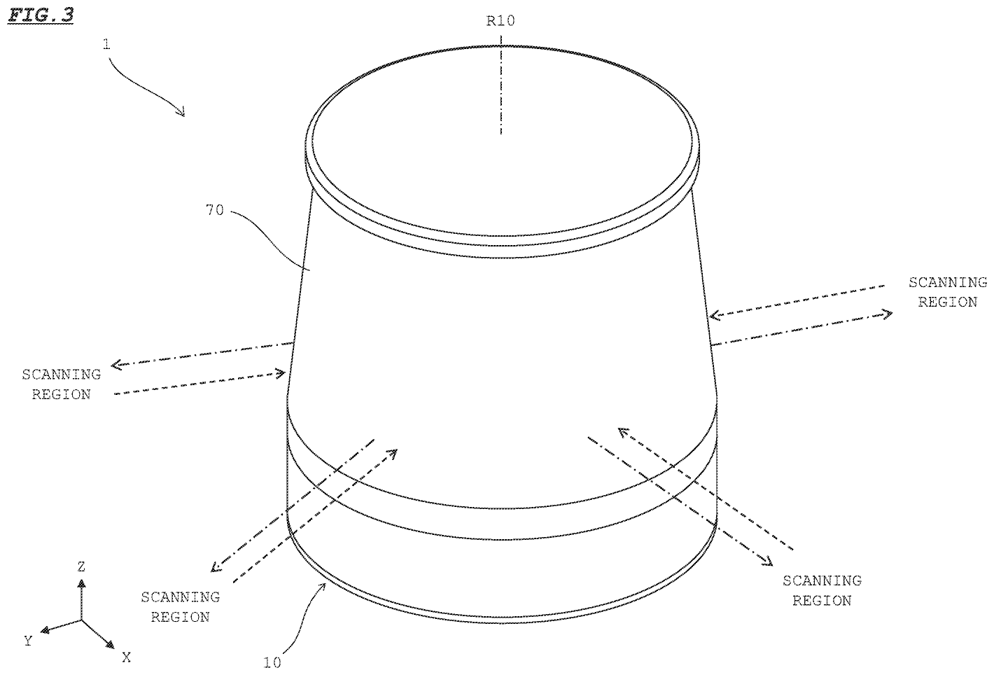

FIG. 1 is a perspective view for illustrating assembly of the laser radar 1. FIG. 2 is a perspective view showing a configuration of the laser radar 1 in a state where assembly of a portion excluding a cover 70 is completed. FIG. 3 is a perspective view showing a configuration of the laser radar 1 in a state where the cover 70 is attached.

As shown in FIG. 1, the laser radar 1 includes a fixing part 10 having a columnar shape, a base member 20 rotatably disposed on the fixing part 10, a disk member 30 installed on the upper surface of the base member 20, and optical units 40 installed on the base member 20 and the disk member 30.

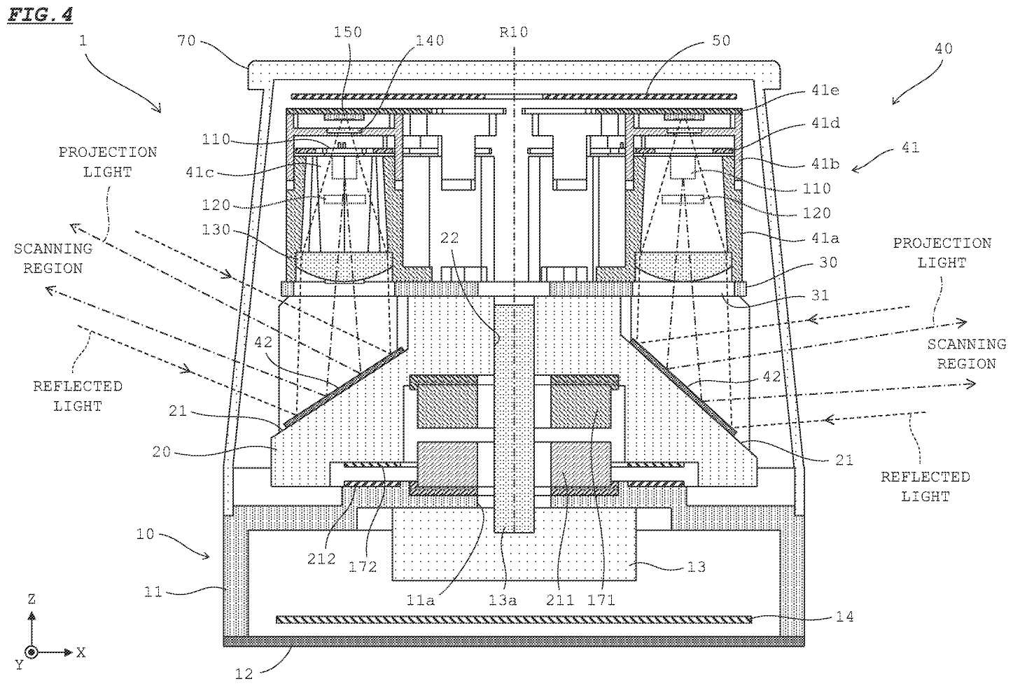

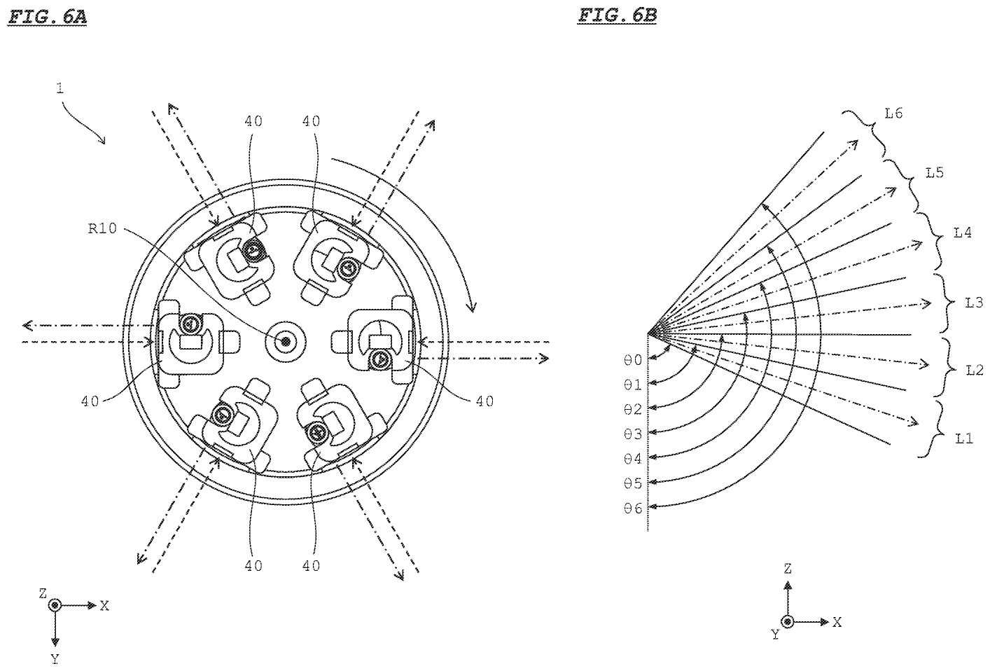

The base member 20 is installed on a drive shaft 13a of a motor 13 (see FIG. 4) provided in the fixing part 10. The base member 20 rotates about a rotation axis R10 parallel to the Z-axis direction by drive of the drive shaft 13a. The base member has a columnar outer shape. In the base member 20, six installation surfaces 21 are formed at equal intervals (60° intervals) along the circumferential direction about the rotation axis R10. Each installation surface 21 is inclined with respect to a plane (X-Y plane) perpendicular to the rotation axis R10. The lateral side (direction away from the rotation axis R10) of the installation surface 21 and the upper side (Z-axis positive direction) of the installation surface 21 are open. The inclination angles of the six installation surfaces 21 are different from each other. The inclination angles of the six installation surfaces 21 will be described later with reference to FIG. 6B.

The disk member 30 is a plate member having an outer shape that is a disk shape. In the disk member 30, six circular holes are formed at equal intervals (60° intervals) along the circumferential direction about the rotation axis R10. Each hole 31 penetrates the disk member 30 in the direction of the rotation axis R10 (Z-axis direction). The disk member 30 is installed on the upper surface of the base member 20 such that the six holes 31 are respectively positioned above the six installation surfaces 21 of the base member 20.

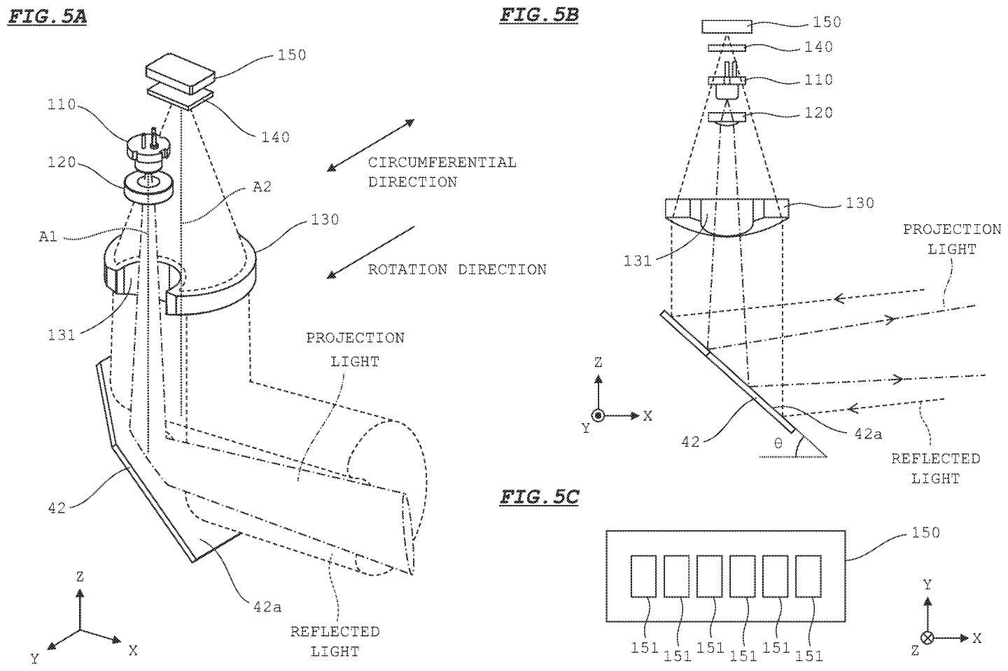

Each optical unit 40 includes a structure 41 and a mirror 42. The structure 41 includes two holding members 41a and 41b, a light blocking member 41c, and two substrates 41d and 41e. The holding members 41a and 41b and the light blocking member 41c hold each component of an optical system included in the structure 41. The holding member 41b is installed on an upper portion of the holding member 41a. The light blocking member 41c is held by the holding member 41a. The substrates 41d and 41e are installed on the upper surfaces of the holding members 41a and 41b, respectively. The structure 41 emits laser light in the downward direction (Z-axis negative direction), and receives laser light from the lower side. The optical system included in the structure 41 will be described later with reference to FIG. 4 and FIG. 5A to FIG. 5C.

As shown in FIG. 1, the structure 41 of each optical unit 40 is installed on a surface 31a around the hole 31 from the upper side of the hole 31 with respect to the structure consisting of the fixing part 10, the base member 20, and the disk member 30. Accordingly, six optical units 40 are arranged at equal intervals (60° intervals) along the circumferential direction about the rotation axis R10. In addition, the mirror 42 of each optical unit 40 is installed on the installation surface 21. The mirror 42 is a plate member in which a surface installed on the installation surface 21 and a reflecting surface 42a on the side opposite to the installation surface 21 are parallel to each other. As described above, an installation region for installing one optical unit 40 is formed by the surface 31a for installing the structure 41 and the installation surface 21 which is located below the surface 31a and which is for installing the mirror 42. In the present embodiment, six installation regions are provided, and the optical unit 40 is installed on each installation region.

Subsequently, a substrate 50 is installed on the upper surfaces of the six optical units 40 as shown in FIG. 2. Accordingly, the assembly of a rotary part 60 including the base member 20, the disk member 30, the six optical units 40, and the substrate 50 is completed. The rotary part 60 rotates about the rotation axis R10 by driving the drive shaft 13a (see FIG. 4) of the motor 13 of the fixing part 10.

Then, in the state shown in FIG. 2, the cover 70 having a cylindrical shape is installed on an outer peripheral portion of the fixing part 10 so as to cover the upper side and the lateral side of the rotary part 60 as shown in FIG. 3. An opening is formed at the lower end of the cover 70, and the inside of the cover 70 is hollow. The rotary part 60 which rotates inside the cover 70 is protected by installing the cover 70. In addition, the cover 70 is made of a material that allows laser light to pass therethrough. The cover 70 is made of, for example, polycarbonate. Accordingly, the assembly of the laser radar 1 is completed.

In detecting an object by the laser radar 1, laser light (projection light) is emitted from a laser light source 110 (see FIG. 4) of each structure 41 in the Z-axis negative direction. The projection light is reflected by the mirror 42 in a direction away from the rotation axis R10. The projection light reflected by the mirror 42 passes through the cover 70 and is emitted to the outside of the laser radar 1. As shown by alternate long and short dash lines in FIG. 3, the projection light is emitted from the cover 70 radially with respect to the rotation axis R10, and projected toward a scanning region located around the laser radar 1. Then, the projection light (reflected light) reflected by an object existing in the scanning region is incident on the cover 70 as shown by broken lines in FIG. 3, and taken into the laser radar 1. The reflected light is reflected by the mirror 42 and received by a photodetector 150 (see FIG. 4) of the structure 41.

The rotary part 60 shown in FIG. 2 rotates around the rotation axis R10. With the rotation of the rotary part 60, the optical axis of each projection light travelling from the laser radar 1 toward the scanning region rotates about the rotation axis R10. Along with this, the scanning region (scanning position of the projection light) also rotates.

The laser radar 1 determines whether or not an object exists in the scanning region, on the basis of whether or not the reflected light is received. In addition, the laser radar 1 measures the distance to the object existing in the scanning region, on the basis of the time difference (time of flight) between the timing when the projection light is projected to the scanning region and the timing when the reflected light is received from the scanning region. When the rotary part 60 rotates about the rotation axis R10, the laser radar 1 can detect objects that exist in substantially the entire range of 360 degrees around the laser radar 1.

FIG. 4 is a cross-sectional view showing a configuration of the laser radar 1.

FIG. 4 shows a cross-sectional view of the laser radar 1 shown in FIG. 3 taken at the center position in the Y-axis direction along a plane parallel to the X-Z plane. In FIG. 4, a flux of the laser light (projection light) emitted from the laser light source 110 of each optical unit 40 and travelling toward the scanning region is shown by an alternate long and short dash line, and a flux of the laser light (reflected light) reflected from the scanning region is shown by a broken line. In addition, in FIG. 4, for convenience, the positions of each laser light source 110 and each collimator lens 120 are shown by dotted lines.

As shown in FIG. 4, the fixing part 10 includes a columnar support base 11, a bottom plate 12, the motor 13, a substrate 14, a non-contact power feeding part 211, and a non-contact communication part 212.

The support base 11 is made of, for example, a resin. The lower surface of the support base 11 is closed by the bottom plate 12 having a circular dish shape. A hole 11a is formed at the center of the upper surface of the support base 11 so as to penetrate the upper surface of the support base 11 in the Z-axis direction. The upper surface of the motor 13 is located around the hole 11a on the inner surface of the support base 11. The motor 13 includes the drive shaft 13a extending in the Z-axis positive direction, and rotates the drive shaft 13a about the rotation axis R10.

The non-contact power feeding part 211 is installed around the hole 11a on the outer surface of the support base 11 along the circumferential direction about the rotation axis R10. The non-contact power feeding part 211 is composed of a coil capable of supplying power to and being supplied with power from a non-contact power feeding part 171 described later. In addition, the non-contact communication part 212 is installed around the non-contact power feeding part 211 on the outer surface of the support base 11 along the circumferential direction about the rotation axis R10. The non-contact communication part 212 is composed of a substrate on which electrodes and the like capable of wireless communication with a non-contact communication part 172 described later are arranged.

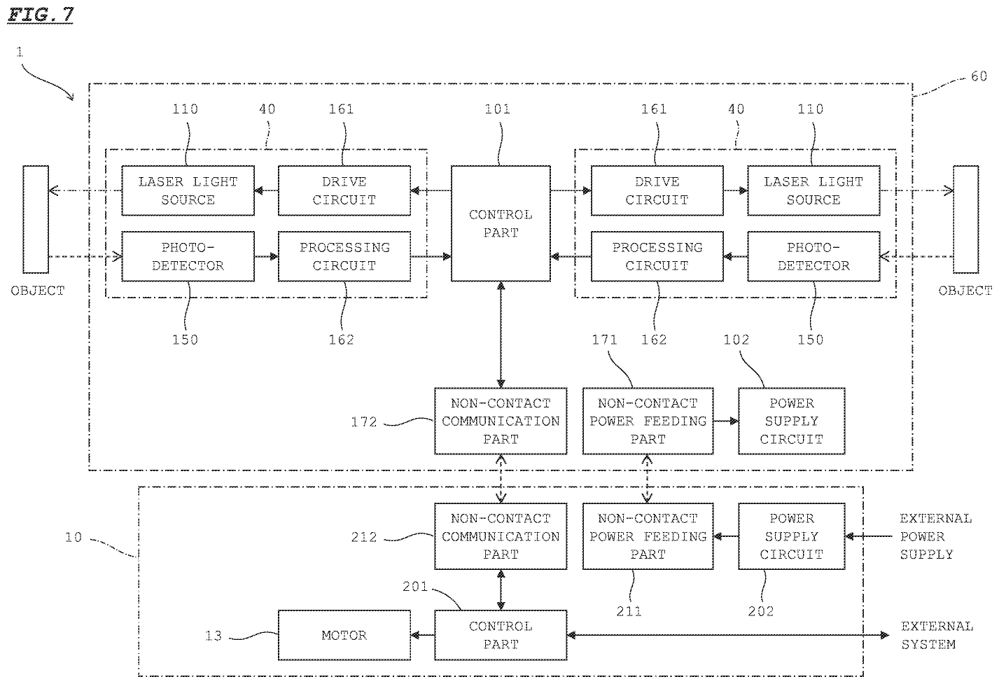

A control part 201 and a power supply circuit 202 (see FIG. 7), which will be described later, are installed on the substrate 14. The motor 13, the non-contact power feeding part 211, and the non-contact communication part 212 are electrically connected to the substrate 14.

A hole 22 is formed at the center of the base member 20 so as to penetrate the base member 20 in the Z-axis direction. By installing the drive shaft 13a of the motor 13 in the hole 22, the base member 20 is supported on the fixing part 10 so as to be rotatable about the rotation axis R10. The non-contact power feeding part 171 is installed around the hole 22 on the lower surface side of the base member 20 along the circumferential direction about the rotation axis R10. The non-contact power feeding part 171 is composed of a coil capable of supplying power to and being supplied with power from the non-contact power feeding part 211 of the fixing part 10. In addition, the non-contact communication part 172 is installed around the non-contact power feeding part 171 on the lower surface side of the base member 20 along the circumferential direction about the rotation axis R10. The non-contact communication part 172 is composed of a substrate on which electrodes and the like capable of wireless communication with the non-contact communication part 212 of the fixing part 10 are arranged.

As described with reference to FIG. 1, the six installation surfaces 21 are formed in the base member 20 along the circumferential direction about the rotation axis R10, and the mirror 42 is installed on each of the six installation surfaces 21. In addition, the disk member 30 is installed on the upper surface of the base member 20. Each optical unit 40 is installed on the upper surface of the disk member 30 such that the hole 31 of the disk member 30 and the opening formed in the lower surface of the holding member 41a coincide with each other.

The structure 41 of each optical unit 40 includes the laser light source 110, the collimator lens 120, a condensing lens 130, a filter 140, and the photodetector 150 as components of the optical system.

Holes are formed in the holding members 41a and 41b and the light blocking member 41c so as to penetrate the holding members 41a and 41b and the light blocking member 41c in the Z-axis direction. The light blocking member 41c is a tubular member. The laser light source 110 is installed on the substrate 41d installed on the upper surface of the holding member 41a, and the emission end face of the laser light source 110 is positioned inside the hole formed in the light blocking member 41c. The collimator lens 120 is positioned inside the hole formed in the light blocking member 41c, and is installed on the side wall of this hole. The condensing lens 130 is held in the hole formed in the holding member 41a. The filter 140 is held in the hole formed in the holding member 41b. The photodetector 150 is installed on the substrate 41e installed on the upper surface of the holding member 41b.

A control part 101 and a power supply circuit 102 (see FIG. 7), which will be described later, are installed on the substrate 50. The six substrates 41d, the six substrates 41e, the non-contact power feeding part 171, and the non-contact communication part 172 are electrically connected to the substrate 50.

Each laser light source 110 emits laser light (projection light) having a predetermined wavelength. The emission optical axis of the laser light source 110 is parallel to the Z-axis. The collimator lens 120 converges the projection light emitted from the laser light source 110. The collimator lens 120 is composed of, for example, an aspherical lens. The projection light converged by the collimator lens 120 is incident on the mirror 42. The projection light incident on the mirror 42 is reflected by the mirror 42 in a direction away from the rotation axis R10. Then, the projection light passes through the cover 70 and is projected to the scanning region.

If an object exists in the scanning region, the projection light projected to the scanning region is reflected by the object. The projection light (reflected light) reflected by the object passes through the cover 70 and is guided to the mirror 42. Then, the reflected light is reflected in the Z-axis positive direction by the mirror 42. The condensing lens 130 converges the reflected light reflected by the mirror 42.

Then, the reflected light is incident on the filter 140. The filter 140 is configured to allow light in the wavelength band of the projection light emitted from the laser light source 110 to pass therethrough and to block light in the other wavelength bands. The reflected light having passed through the filter 140 is guided to the photodetector 150. The photodetector 150 receives the reflected light and outputs a detection signal corresponding to the amount of the received light. The photodetector 150 is, for example, an avalanche photodiode.

FIG. 5A is a perspective view showing a configuration of the optical system of the optical unit 40. FIG. 5B is a side view showing the configuration of the optical system of the optical unit 40. FIG. 5C is a schematic diagram showing a configuration of sensors 151 of the photodetector 150.

FIG. 5A to FIG. 5C show the optical unit 40 and the photodetector 150 that are located on the X-axis positive side of the rotation axis R10 in FIG. 4. In FIG. 5A to FIG. 5C, for convenience, the optical unit 40 and the photodetector 150 that are located on the X-axis positive side of the rotation axis R10 in FIG. 4 are shown, but the other optical units 40 have the same configuration.

As shown in FIG. 5A and FIG. 5B, the laser light source 110 is a surface-emitting laser light source having a light emission surface that is longer in the X-axis direction than in the Y-axis direction. In addition, the collimator lens 120 is configured such that the curvature in the X-axis direction and the curvature in the Y-axis direction thereof are equal to each other, and the laser light source 110 is installed at a position closer to the collimator lens 120 than the focal distance of the collimator lens 120. Accordingly, as shown in FIG. 5A, the projection light reflected by the mirror 42 is projected to a projection region in a slightly diffused state. In addition, a flux of the projection light reflected by the mirror 42 has a longer length in a direction (Z-axis direction) parallel to the rotation axis R10 than that in the Y-axis direction.

The reflected light from the scanning region is reflected in the Z-axis positive direction by the mirror 42 and is then incident on the condensing lens 130. An optical axis A1 of a projection optical system (the laser light source 110 and the collimator lens 120) for projecting the projection light and an optical axis A2 of a light-receiving optical system (the condensing lens 130) for receiving the reflected light are each parallel to the Z-axis direction and are separated from each other by a predetermined distance in the circumferential direction about the rotation axis R10.

Here, in the present embodiment, the optical axis A1 of the projection optical system is included in the effective diameter of the condensing lens 130, and thus an opening 131 through which the optical axis A1 of the projection optical system passes is formed in the condensing lens 130. The opening 131 is formed on the outer side with respect to the center of the condensing lens 130, and is a cutout penetrating the condensing lens 130 in the Z-axis direction. By providing the opening 131 in the condensing lens 130 as described above, the optical axis A1 of the projection optical system and the optical axis A2 of the light-receiving optical system can be made closer to each other, and the laser light emitted from the laser light source 110 can be incident on the mirror 42 almost without being incident on the condensing lens 130.

The light blocking member 41c shown in FIG. 4 covers the optical axis A1 of the projection optical system and also extends from the position of the laser light source 110 to the lower end of the opening 131. In addition, the light blocking member 41c is fitted into the opening 131. Accordingly, the laser light emitted from the laser light source 110 can be inhibited from being incident on the condensing lens 130.

In the present embodiment, the rotary part 60 is rotated clockwise about the rotation axis R10 when viewed in the Z-axis negative direction. Accordingly, each component of the optical unit 40 located on the X-axis positive side of the rotation axis R10 shown in FIG. 5A is rotated in the Y-axis positive direction. As described above, in the present embodiment, the optical axis A2 of the light-receiving optical system is located at a position on the rear side in the rotation direction of the rotary part 60 with respect to the optical axis A1 of the projection optical system.

As shown in FIG. 5B, the projection light incident on the mirror 42 is reflected in a direction corresponding to an angle 19, with respect to the X-Y plane, of the reflecting surface 42a of the mirror 42. As described above, the laser radar 1 includes the six optical units 40, and the inclination angles, with respect to the plane (X-Y plane) perpendicular to the rotation axis R10, of the installation surfaces 21 on which the mirrors 42 of the respective optical units 40 are installed are different from each other. Therefore, the inclination angles of the reflecting surfaces 42a of the six mirrors 42 respectively installed on the six installation surfaces 21 are also different from each other. Therefore, the projection lights reflected by the respective mirrors 42 are projected to scanning positions different from each other in the direction (Z-axis direction) parallel to the rotation axis R10.

As shown in FIG. 5C, the photodetector 150 includes the six sensors 151 on the Z-axis negative side. The six sensors 151 are arranged adjacently in a line in the X-axis direction. The direction in which the six sensors 151 are arranged corresponds to the Z-axis direction of the scanning range (direction parallel to the rotation axis R10). That is, the reflected light is incident on the six sensors 151 from six division regions into which the scanning range is divided in the Z-axis direction. Therefore, an object existing in each division region can be detected on the basis of a detection signal from each sensor 151. The resolution of object detection in the scanning range is increased in the Z-axis direction by increasing the number of sensors 151.

FIG. 6A is a top view of the laser radar 1 as viewed in the Z-axis negative direction. In FIG. 6A, for convenience, the cover 70, the substrate 50, the holding member 41b, and the substrates 41d and 41e are not shown.

The six optical units 40 rotate about the rotation axis R10. At this time, the six optical units 40 project the projection light in directions away from the rotation axis R10 (radially as viewed in the Z-axis direction). While rotating at a predetermined speed, the six optical units 40 project the projection light to the scanning region, and receive the reflected light from the scanning region. Accordingly, object detection is performed over the entire circumference (360°) around the laser radar 1.

FIG. 6B is a schematic diagram showing a projection angle of the projection light of each optical unit 40 when each optical unit 40 is positioned on the X-axis positive side of the rotation axis R10.

As described above, the installation angles of the six mirrors 42 are different from each other. Accordingly, the angles of six fluxes L1 to L6 of the projection light emitted from the six optical units 40, respectively, are also different from each other. In FIG. 6B, the optical axes of the six fluxes L1 to L6 are shown by alternate long and short dash lines. Angles θ0 to θ6 indicating the angle ranges of the fluxes L1 to L6 are angles with respect to the direction (Z-axis direction) parallel to the rotation axis R10. In the present embodiment, the angles θ0 to θ6 are set such that the fluxes next to each other substantially adjoin to each other. That is, the distribution ranges of the fluxes L1, L2, L3, L4, L5, and L6 have an angle θ0-θ1, an angle θ1-θ2, an angle θ2-θ3, an angle θ3-θ4, an angle θ4-θ5, and an angle θ5-θ6. Accordingly, the projection lights from the respective optical units 40 are projected to scanning positions adjoining to each other in the direction (Z-axis direction) parallel to the rotation axis R10.

FIG. 7 is a circuit block diagram showing the configuration of the laser radar 1.

The laser radar 1 includes the control part 101, the power supply circuit 102, a drive circuit 161, a processing circuit 162, the non-contact power feeding part 171, the non-contact communication part 172, the control part 201, the power supply circuit 202, the non-contact power feeding part 211, and the non-contact communication part 212 as components of circuitry. The control part 101, the power supply circuit 102, the drive circuit 161, the processing circuit 162, the non-contact power feeding part 171, and the non-contact communication part 172 are disposed in the rotary part 60. The control part 201, the power supply circuit 202, the non-contact power feeding part 211, and the non-contact communication part 212 are disposed in the fixing part 10.

The power supply circuit 202 is connected to an external power supply, and power is supplied from the external power supply to each component of the fixing part 10 via the power supply circuit 202. The power supplied to the non-contact power feeding part 211 is supplied to the non-contact power feeding part 171 in response to the rotation of the rotary part 60. The power supply circuit 102 is connected to the non-contact power feeding part 171, and the power is supplied from the non-contact power feeding part 171 to each component of the rotary part 60 via the power supply circuit 102.

The control parts 101 and 201 each include an arithmetic processing circuit and a memory, and are each composed of, for example, an FPGA or MPU. The control part 101 controls each component of the rotary part 60 according to a predetermined program stored in the memory thereof, and the control part 201 controls each component of the fixing part 10 according to a predetermined program stored in the memory thereof. The control part 101 and the control part 201 are communicably connected to each other via the non-contact communication parts 172 and 212.

The control part 201 is communicably connected to an external system. The external system is, for example, an intrusion detection system, a car, a robot, or the like. The control part 201 drives each component of the fixing part 10 in accordance with the control from the external system, and transmits a drive instruction to the control part 101 via the non-contact communication parts 212 and 172. The control part 101 drives each component of the rotary part 60 in accordance with the drive instruction from the control part 201, and transmits a detection signal to the control part 201 via the non-contact communication parts 172 and 212.

The drive circuit 161 and the processing circuit 162 are provided in each of the six optical units 40. The drive circuit 161 drives the laser light source 110 in accordance with the control from the control part 101. The processing circuit 162 performs processing such as amplification and noise removal on detection signals inputted from the sensors 151 of the photodetector 150, and outputs the resultant signals to the control part 101.

In the detection operation, while controlling the motor 13 to rotate the rotary part 60 at a predetermined rotation speed, the control part 201 controls the six drive circuits 161 to emit laser light (projection light) from each laser light source 110 at a predetermined rotation angle at a predetermined timing. Accordingly, the projection light is projected from the rotary part 60 to the scanning region, and the reflected light is received by the sensors 151 of the photodetector 150 of the rotary part 60. The control part 201 determines whether or not an object exists in the scanning region, on the basis of detection signals outputted from the sensors 151. In addition, the control part 201 measures the distance to the object existing in the scanning region, on the basis of the time difference (time of flight) between the timing when the projection light is projected and the timing when the reflected light is received from the scanning region.

### Effects of Embodiment

According to the embodiment described above, the following effects are achieved.

As shown in FIG. 6A, when the base member 20 rotates about the rotation axis R10, a range in the circumferential direction centered on the rotation axis R10 is scanned with the projection light emitted from each optical unit 40. At this time, since the projection directions of the projection lights from the respective optical units 40 are different from each other in the direction (Z-axis direction) parallel to the rotation axis R10 as shown in FIG. 6B, the ranges scanned with the respective projection lights are shifted from each other in the direction parallel to the rotation axis R10. Therefore, the entire range scanned with these projection lights is a wide range obtained by integrating the scanning ranges of the respective laser lights shifted from each other in the direction parallel to the rotation axis R10. Therefore, the scanning range in the direction parallel to the rotation axis R10 can be effectively expanded. Moreover, when the scanning range in the direction parallel to the rotation axis R10 is expanded as described above, an object can be detected in the wide scanning range parallel to the rotation axis R10.

Each optical unit 40 includes the laser light source 110 and the mirror 42 which bends the optical axis of the laser light source 110. In addition, as shown in FIG. 6B, the bending angle of the optical axis by the mirror 42 is different for each optical unit 40. Accordingly, the projection direction of the projection light projected from each optical unit 40 can be adjusted merely by adjusting the installation angle of the mirror 42.

By using the mirror 42 as an optical element that bends the optical axis of the laser light source 110 as described above, the attenuation of the projection light emitted from the structure 41 can be suppressed, and the power of the projection light projected to the scanning range can be ensured.

In the base member 20, the six installation surfaces 21 for installing the mirrors 42 are formed in the installation regions in which the six optical units 40 are installed, respectively. In addition, the inclination angle of each of the six installation surfaces 21 with respect to the plane (X-Y plane) perpendicular to the optical axis of the laser light source 110 is different for each installation region of the optical unit 40. Accordingly, by merely installing the mirror 42 on each installation surface 21, the mirror 42 can be installed at a desired inclination angle on the base member 20. Therefore, the projection direction of the projection light projected from each optical unit 40 can be easily adjusted.

The laser light source 110 is a surface-emitting laser light source having a light emission surface that is longer in one direction. In addition, each optical unit 40 includes the collimator lens 120 on which the laser light (projection light) emitted from the laser light source 110 is incident. Furthermore, the laser light source 110 is installed such that the longitudinal direction of the light emission surface of the laser light source 110 coincides with the direction (Z-axis direction) parallel to the rotation axis R10 when the projection light is projected. Accordingly, the projection light projected from the optical unit 40 can be smoothly expanded in the direction (Z-axis direction) parallel to the rotation axis R10.

The photodetector 150 includes the six sensors 151 separated from each other in a direction (X-axis direction) corresponding to the direction (Z-axis direction) parallel to the rotation axis R10. Accordingly, the reflected light from each position in the scanning region in the direction parallel to the rotation axis R10 can be received by each sensor 151. Therefore, the state at each position in the scanning region can be detected on the basis of an output signal from each sensor 151.

As shown in FIG. 5A, in each of the six optical units 40, the optical axis A1 of the projection optical system (the laser light source 110 and the collimator lens 120) for projecting the projection light and the optical axis A2 of the light-receiving optical system (the condensing lens 130) for receiving the reflected light are parallel to each other. In addition, the opening 131 through which the optical axis A1 of the projection optical system passes is provided in the condensing lens 130. Accordingly, the optical axis A1 and the optical axis A2 can be made closer to each other, so that the optical unit 40 can be made compact while ensuring a wide effective diameter of the condensing lens 130. In addition, since the optical axis A1 and the optical axis A2 can be made closer to each other, the reflected light of the projection light projected from the optical unit 40 is easily received by the photodetector 150.

As shown in FIG. 4, the light blocking member 41c covers the area around the optical axis A1 of the projection optical system and also extends from the position of the laser light source 110 to the lower end of the opening 131. In addition, the light blocking member 41c is fitted into the opening 131. By limiting the optical path of the projection light emitted from the laser light source 110 as described above, the projection light before projection can be inhibited from being incident on the condensing lens 130, and the projection light reflected on the surface of the condensing lens 130 can be inhibited from becoming stray light and being incident on the photodetector 150. Therefore, the accuracy of object detection can be improved.

As shown in FIG. 5A, the optical axis A1 of the projection optical system and the optical axis A2 of the light-receiving optical system are aligned in the circumferential direction of the rotation axis R10, and the optical axis A2 of the light-receiving optical system is located at a position on the rear side in the rotation direction of the rotary part 60 with respect to the optical axis A1 of the projection optical system. Accordingly, in the duration from the time when the laser light is projected to the time when the laser light is received, the optical axis A2 of the light-receiving optical system comes closer to the position of the optical axis A1 of the projection optical system at the timing when the laser light is projected. Thus, the reflected light can be more favorably received by the light-receiving optical system.

<Modification>

In the configuration in which the six optical units 40 are arranged at equal intervals (60° intervals) along the circumferential direction about the rotation axis R10 as in the above embodiment, control in which the six optical units 40 are caused to simultaneously emit light at the timing when the six optical units 40 are respectively positioned at angle positions obtained when the entire circumference is equally divided, can be performed. For example, when the rotary part 60 is rotated at a constant angular velocity, control in which the six optical units 40 are caused to simultaneously emit light every time the rotary part 60 rotates by an angle (for example, 1°) by which the entire circumference is equally divided, is performed. Accordingly, at an angle position at which the projection light is projected in one optical unit 40, the projection light can be projected from the optical unit 40 following the one optical unit 40. That is, the projection position of the projection light in each optical unit 40 can be caused to coincide in the circumferential direction. Accordingly, the detection position of an object by each projection light can also be caused to coincide in the circumferential direction. As a result, when a distance image of the entire circumference of the scanning range is generated by integrating the measured distances at the respective detection positions, the distance image can be smoothly generated.

However, the control in which the six optical units 40 are caused to simultaneously emit light as described above has a problem that the instantaneous power consumption is high and the control becomes complicated. Therefore, it is preferable that the respective optical units 40 are caused to emit light at different timings.

Therefore, in the present modification, a configuration for causing the projection position of the projection light in each optical unit 40 to coincide in the circumferential direction while causing the respective optical units 40 to emit light at different timings, is used.

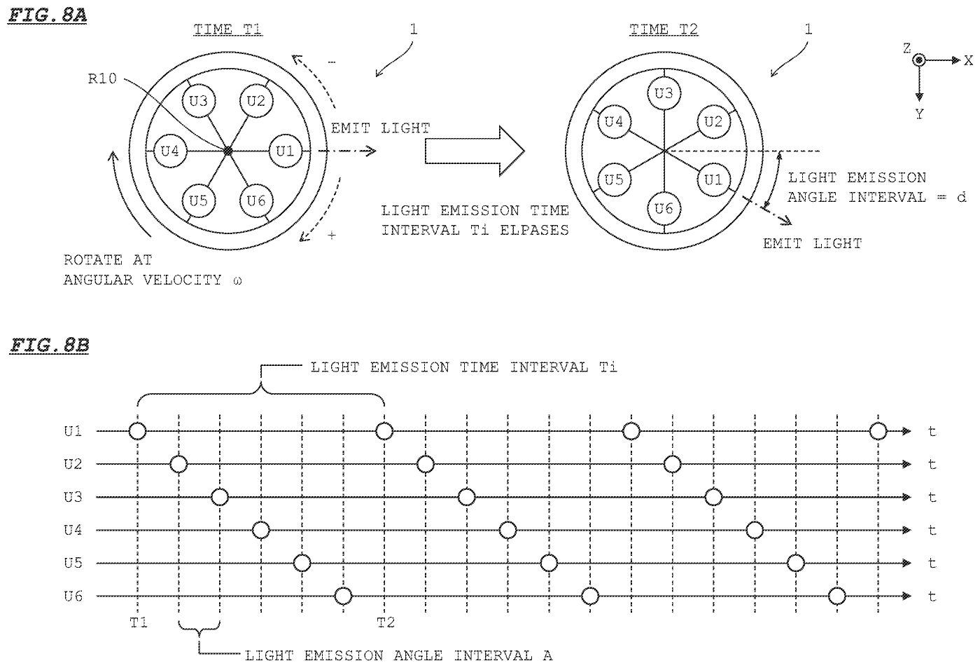

First, the fact that the emission positions (emission angles with respect to a reference angle position) in the circumferential direction of the six optical units 40 are shifted from each other when the six optical units 40 are caused to sequentially emit light at equally spaced timings while rotating the rotary part 60 at a constant angular velocity in the case where the six optical units 40 are arranged at equal intervals as in the above embodiment, will be described below with reference to FIG. 8A to FIG. 10.

FIG. 8A is a schematic diagram for illustrating a light emission angle interval and a light emission time interval.

For convenience, the six optical units 40 are referred to as optical units U1, U2, U3, U4, U5, and U6. The optical units U1 to U6 are arranged at 60° intervals along the circumferential direction about the rotation axis R10. When viewed in the Z-axis negative direction, the position on the X-axis positive side of the rotation axis R10 is defined as 0° (reference angle position), an angle clockwise from 0° is defined as a positive angle, and an angle counterclockwise from 0° is defined as a negative angle. In addition, the six optical units U1 to U6 rotate clockwise at a constant angular velocity ω (deg/sec).

It is assumed that the optical unit U1 at the position of 0° at time T1 rotates to the position at an angle d (deg) at time T2, and the six optical units U1 to U6 are caused to sequentially emit light at equal time intervals during this period. The angle by which the six optical units U1 to U6 rotate while being caused to sequentially emit light as described above is referred to as a light emission angle interval d. In addition, the time required for the optical units U1 to U6 to rotate by the light emission angle interval d is referred to as a light emission time interval Ti. The light emission time interval Ti can be represented by d/ω.

FIG. 8B is a schematic diagram showing light emission timings of the six optical units U1 to U6 in response to the passage of time. In FIG. 8B, the horizontal axis indicates time, and circles on number lines indicate light emission timings.

After the optical unit U1 is caused to emit light at time T1, the optical units U2 to U6 are caused to sequentially emit light until the light emission time interval Ti elapses to reach time T2. Here, the light emission interval of each optical unit is referred to as an adjacent light emission time interval A. The adjacent light emission time interval A is obtained by dividing the light emission time interval Ti by the number of optical units (six in this example), and can be represented by Ti/6.

Next, the emission angles of the six optical units U1 to U6 when the laser lights (projection lights) are emitted from the six optical units U1 to U6 at the light emission timings as in FIG. 8B, will be described.

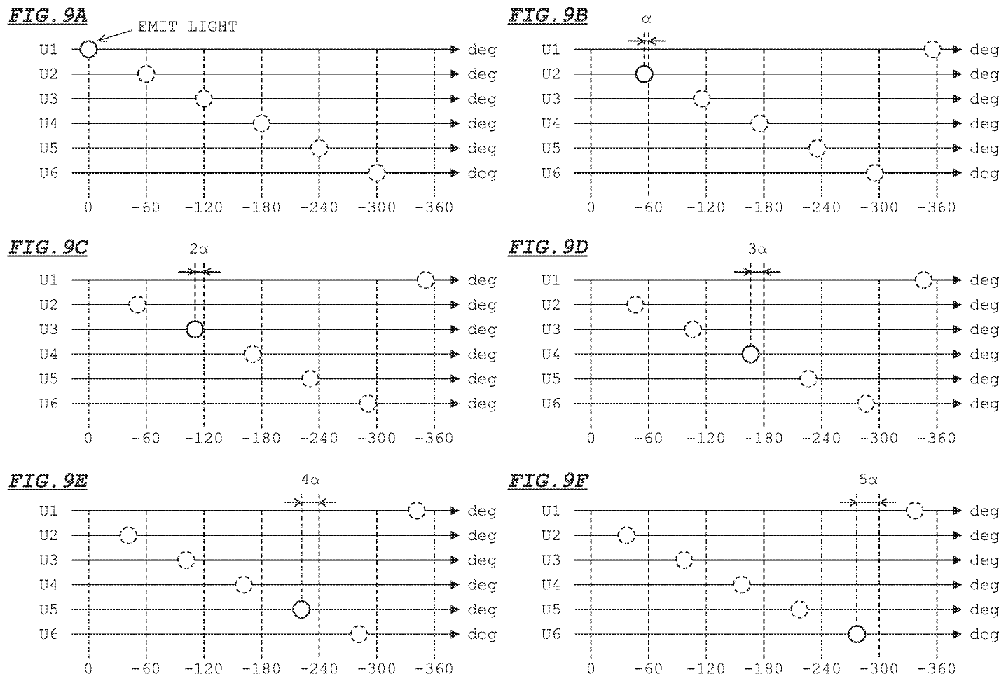

FIG. 9A to FIG. 9F are diagrams showing positions (angles) at which the six optical units U1 to U6 emit light. In FIG. 9A to FIG. 9F, the horizontal axis indicates the angle (deg), solid line circles on number lines indicate the positions (angles) of the optical units when the optical units emit light, and broken line circles on the number lines indicate the positions (angles) of the optical units at which the optical units do not emit light.

As shown in FIG. 9A, when the optical unit U1 emits light at 0°, the optical units U2 to U6 are located at positions of −60°, −120°, −180°, −240°, and −300°, respectively.

The time from the time when the optical unit U1 emits light to the time when the optical unit U2 emits light is the adjacent light emission time interval A as shown in FIG. 8B. Since the optical units U1 to U6 continue to rotate at the angular velocity co, the optical units U1 to U6 rotate by an angle α until the adjacent light emission time interval A elapses. The angle α can be represented by Aω or d/6. Therefore, as shown in FIG. 9B, the optical unit U2 emits light at a position that advances by the angle α from the position thereof in FIG. 9A. At this time, the optical units U1 and U3 to U6 are also at positions that advance by the angle α from the positions thereof in FIG. 9A.

Subsequently, the optical units U1 to U6 rotate by the angle α during the period from the time when the optical unit U2 emits light to the time when the adjacent light emission time interval A elapses. Therefore, as shown in FIG. 9C, the optical unit U3 emits light at a position that advances by an angle 2α from the position thereof in FIG. 9A (position that advances by the angle α from the position thereof in FIG. 9B).

Similarly, as shown in FIG. 9D, the optical unit U4 emits light at a position that advances by an angle 3a from the state of FIG. 9A (position that advances by the angle α from the position thereof in FIG. 9C). As shown in FIG. 9E, the optical unit U5 emits light at a position that advances by an angle 4a from the state of FIG. 9A (position that advances by the angle α from the position thereof in FIG. 9D). As shown in FIG. 9F, the optical unit U6 emits light at a position that advances by an angle 5α from the state of FIG. 9A (position that advances by the angle α from the position thereof in FIG. 9E).

Subsequently, by advancing by the angle α from the state of FIG. 9F, the optical units U1 to U6 rotate by the light emission angle interval d from the state of FIG. 9A, and the light emission time interval Ti elapses. Then, light emission of the optical units U1 to U6 is repeated in the same manner as in FIG. 9A to FIG. 9F.

FIG. 10 is a diagram showing positions (angles) at which each optical unit emits light until the six optical units U1 to U6 rotate 360°. In FIG. 10, the horizontal axis indicates the angle (deg), and solid line circles on number lines indicate the positions (angles) of the optical units when the optical units emit light.

The light emission of the six optical units U1 to U6 (light emission in one frame) performed while the six optical units U1 to U6 rotate by the light emission angle interval d (while the light emission time interval Ti elapses) is repeated. When the six optical units U1 to U6 have rotated 360°, the emission positions (emission angles) of the six optical units U1 to U6 are shifted from each other in the horizontal direction (circumferential direction) as shown in FIG. 10.

As described above, it can be seen that in the case where the six optical units U1 to U6 are arranged at equal intervals, when the six optical units U1 to U6 rotate about the rotation axis R10 at a constant angular velocity and are caused to emit light at equal time intervals (adjacent light emission time intervals A), the emission angles (light-reception angles) of the reflected lights received by the six optical units U1 to U6 are shifted from each other. If the emission angles are shifted from each other as described above, when a distance image is generated on the basis of the detection signals outputted from the six optical units U1 to U6, the generated image is distorted. Therefore, further processing for correcting this distortion is required.

In the present modification, the arrangement of the six optical units U1 to U6 is changed from the arrangement at equal intervals in order to reduce such shift of the emission angles in the six optical units U1 to U6.

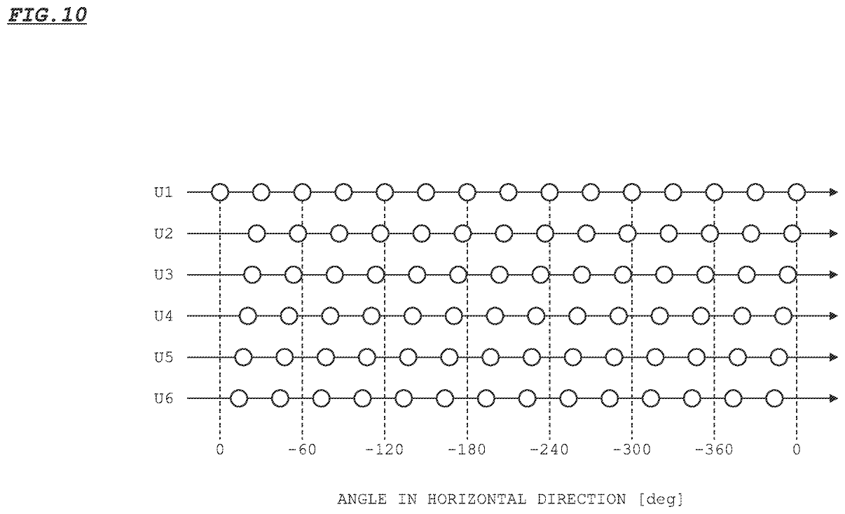

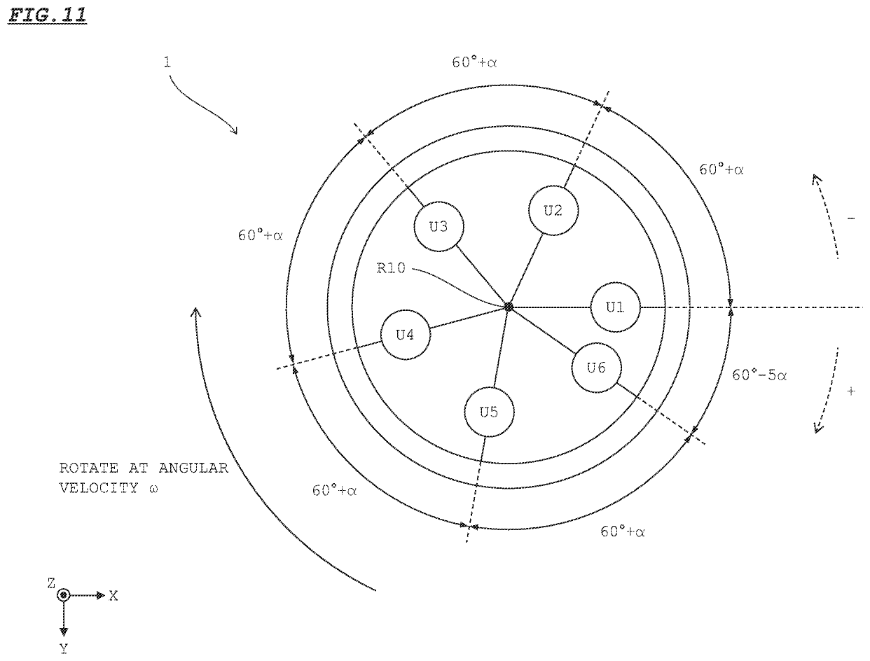

FIG. 11 is a schematic diagram showing the arrangement of the optical units U1 to U6 according to the present modification.

In the present modification, the optical unit U1 is disposed at the position of 0°. The optical unit U2 is disposed so as to be spaced apart from the optical unit U1 by 60°+a in the negative rotation direction. Similarly, the optical unit U3 is disposed so as to be spaced apart from the optical unit U2 by 60°+α in the negative rotation direction. The optical unit U4 is disposed so as to be spaced apart from the optical unit U3 by 60°+α in the negative rotation direction. The optical unit U5 is disposed so as to be spaced apart from the optical unit U4 by 60°+α in the negative rotation direction. The optical unit U6 is disposed so as to be spaced apart from the optical unit U5 by 60°+α in the negative rotation direction. Accordingly, the interval between the optical unit U1 and the optical unit U6 is 60°−5α.

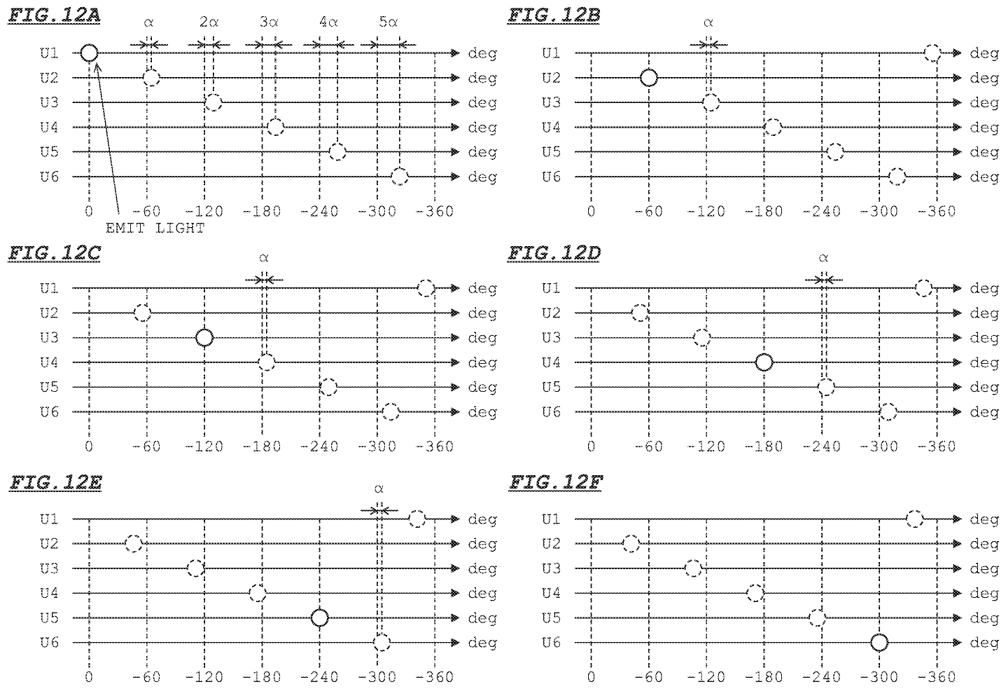

FIG. 12A to FIG. 12F are diagrams showing positions (angles) at which the six optical units U1 to U6 according to the present modification emit light.

As shown in FIG. 12A, when the optical unit U1 emits light at 0°, the optical units U2 to U6 are located at positions of −60°−α, −120°−2α, −180°−3α, −240°−4α, and −300°−5α, respectively.

During the period from the time when the optical unit U1 emits light to the time when the adjacent light emission time interval A elapses, the optical units U1 to U6 rotate by the angle α. Therefore, as shown in FIG. 12B, the optical unit U2 emits light at the position of −60°. At this time, the optical units U1 and U3 to U6 are at positions that advance by the angle α from the positions thereof in FIG. 12A, and the optical unit U3 is positioned at −120°−α.

Similarly, as shown in FIG. 12C, the optical unit U3 emits light at the position of −120°. As shown in FIG. 12D, the optical unit U4 emits light at the position of −180°. As shown in FIG. 12E, the optical unit U5 emits light at the position of −240°. As shown in FIG. 12F, the optical unit U6 emits light at the position of −300°.

Subsequently, by advancing by the angle α from the state of FIG. 12F, the optical units U1 to U6 rotate by the light emission angle interval d from the state of FIG. 12A, and the light emission time interval Ti elapses. Then, light emission of the optical units U1 to U6 is repeated in the same manner as in FIG. 12A to FIG. 12F.

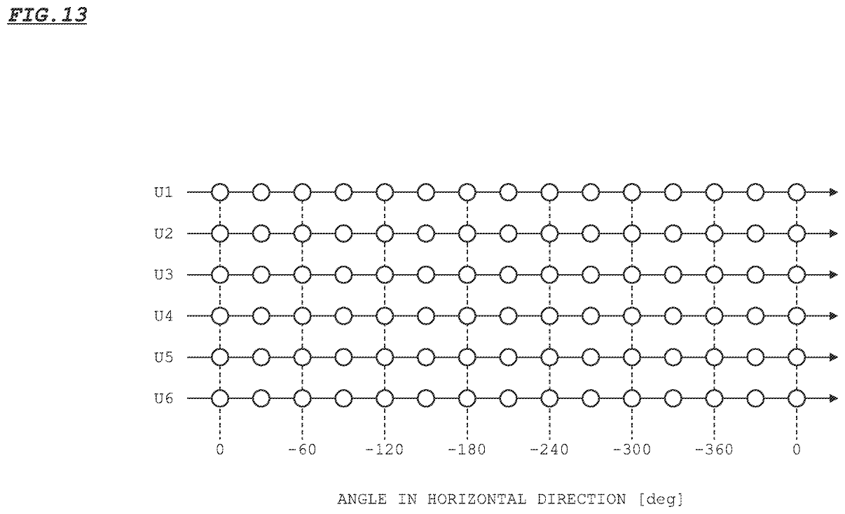

FIG. 13 is a diagram showing positions (angles) at which each optical unit emits light until the six optical units U1 to U6 according to the present modification rotate 360°.

The light emission of the six optical units U1 to U6 (light emission in one frame) performed while the six optical units U1 to U6 rotate by the light emission angle interval d (while the light emission time interval Ti elapses) is repeated. In the present modification, when the six optical units U1 to U6 have rotated 360°, the emission positions (emission angles) of the six optical units U1 to U6 coincide in the horizontal direction (circumferential direction) as shown in FIG. 13.

As described above, in the present modification, the six optical units U1 to U6 project laser light at times different from each other. Then, the installation position of each optical unit with respect to the base member 20 is set to a position displaced from an equal angle position in the circumferential direction by a predetermined angle, such that each optical unit projects laser light at the equal angle position in the circumferential direction.

Specifically, in the case where the six optical units U1 to U6 rotate at the constant angular velocity ω about the rotation axis R10 and are caused to emit light at equal time intervals (adjacent light emission time intervals A), the optical units U1 to U6 are disposed as shown in FIG. 11. Accordingly, the emission angles (light-reception angles) of the six optical units U1 to U6 can be caused to coincide. Therefore, even when a distance image is generated as described above on the basis of the detection signals outputted from the six optical units U1 to U6, distortion of the generated image can be suppressed.

<Other Modifications>

The configuration of the laser radar 1 can be modified in various ways other than the configuration shown in the above embodiment.

For example, in the above embodiment, the photodetector 150 includes the six sensors 151 separated from each other in the direction (radial direction of a circle centered on the rotation axis R10) corresponding to the direction (Z-axis direction) parallel to the rotation axis R10, but the number of sensors 151 disposed in the photodetector 150 is not limited thereto. For example, two to five sensors may be provided in the photodetector 150, or seven or more sensors may be provided in the photodetector 150. As the number of sensors disposed in the photodetector 150 is increased, the resolution of object detection in the direction parallel to the rotation axis R10 can be increased.

The photodetector 150 does not necessarily have to include a plurality of sensors, and may include one sensor 152 which is long in the radial direction from the rotation axis R10.

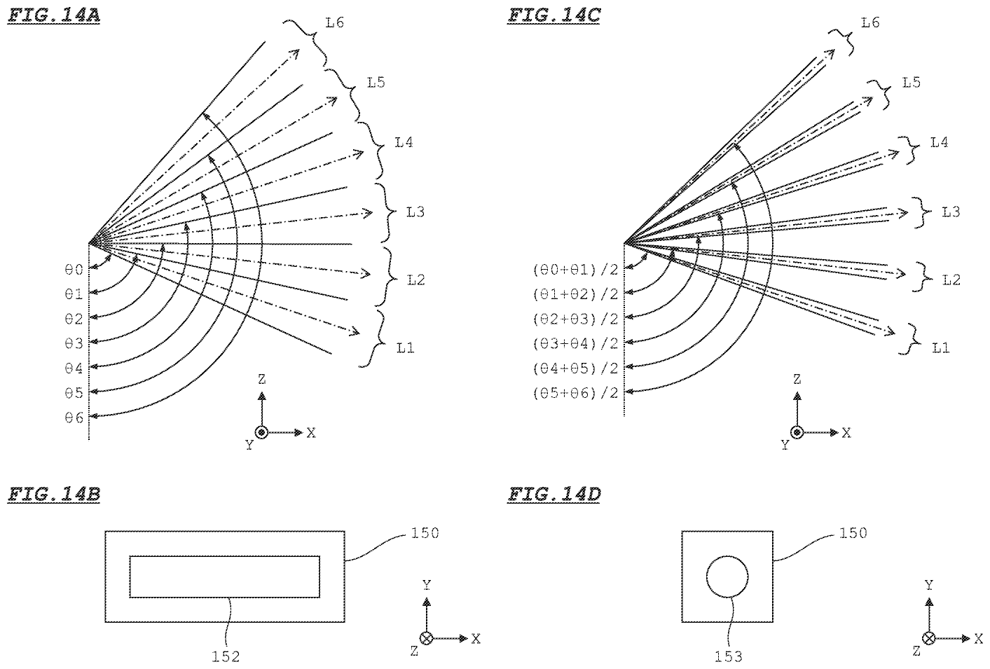

FIG. 14A is a schematic diagram showing the six fluxes L1 to L6 according to this modification, and FIG. 14B is a schematic diagram showing a configuration of the photodetector 150 according to this modification. FIG. 14B shows the photodetector 150 when the optical units 40 are positioned on the X-axis positive side of the rotation axis R10.

As shown in FIG. 14A, in this modification as well, similar to the above embodiment, a scanning range that is long in the direction (Z-axis direction) parallel to the rotation axis R10 is scanned corresponding to the fluxes L1 to L6. Then, similar to the above embodiment, the reflected light from the scanning range corresponding to each flux is long in the Z-axis direction, and thus is long in the X-axis direction on the light receiving surface of the photodetector 150. The length in the X-axis direction of the sensor 152 shown in FIG. 14B is set in the same manner as the overall length in the X-axis direction of the plurality of sensors 151 of the above embodiment.

According to this modification, the reflected light from each scanning range is received by one sensor 152. Therefore, although the resolution of the photodetector 150 corresponding to the Z-axis direction of each scanning range is lower than that of the above embodiment, the configuration of the photodetector 150 can be simplified. In addition, in this modification as well, similar to the above embodiment, the width in the Z-axis direction of the entire scanning range can be widened.

In the above embodiment, each laser light source 110 is a surface-emitting laser light source having a light emission surface that is longer in one direction, but is not limited thereto, and may be an end face-emitting laser light source.

FIG. 14C is a diagram showing the fluxes L1 to L6 according to this modification, and FIG. 14D is a schematic diagram showing a configuration of the photodetector 150 according to this modification.

As shown in FIG. 14C, in this modification, the lengths in the direction (Z-axis direction) parallel to the rotation axis R10 of the fluxes L1 to L6 are shorter than those of the above embodiment. Accordingly, the fluxes L1 to L6 are distributed only in predetermined angle ranges including angles (θ0+θ1)/2, (θ1+θ2)/2, (θ2+θ3)/2, (θ3+θ4)/2, (θ4+θ5)/2, and (θ5+θ6)/2, respectively. Therefore, the reflected light from each scanning range is shorter in the Z-axis direction than that of the above embodiment, and thus is shorter in the X-axis direction on the light receiving surface of the photodetector 150. Therefore, as shown in FIG. 14D, the photodetector 150 of this modification includes one sensor 153 which is substantially circular, and the reflected light from each scanning range is received by the sensor 153.

In this modification as well, similar to the above embodiment, the width in the Z-axis direction of the entire scanning range can be widened. However, in this modification, as shown in FIG. 14C, a range in which the projection light is not projected is included between the fluxes, so that detection omission of an object is likely to occur. Therefore, in order to improve the accuracy of object detection, it is preferable to widen the widths of the fluxes in the direction parallel to the rotation axis R10 as in the above embodiment to suppress the formation of a gap between the fluxes. In this modification as well, the number of sensors 153 does not necessarily have to be one, and a plurality of sensors separated from each other in the X-axis direction may be disposed in the photodetector 150. Accordingly, the resolution of object detection can be increased.

In the above embodiment, the projection light is directed to the scanning region by the mirror 42, but a spectroscopic element that splits the projection light in the direction parallel to the rotation axis R10 may be further disposed. In this case, for example, a diffraction grating is used as the spectroscopic element.

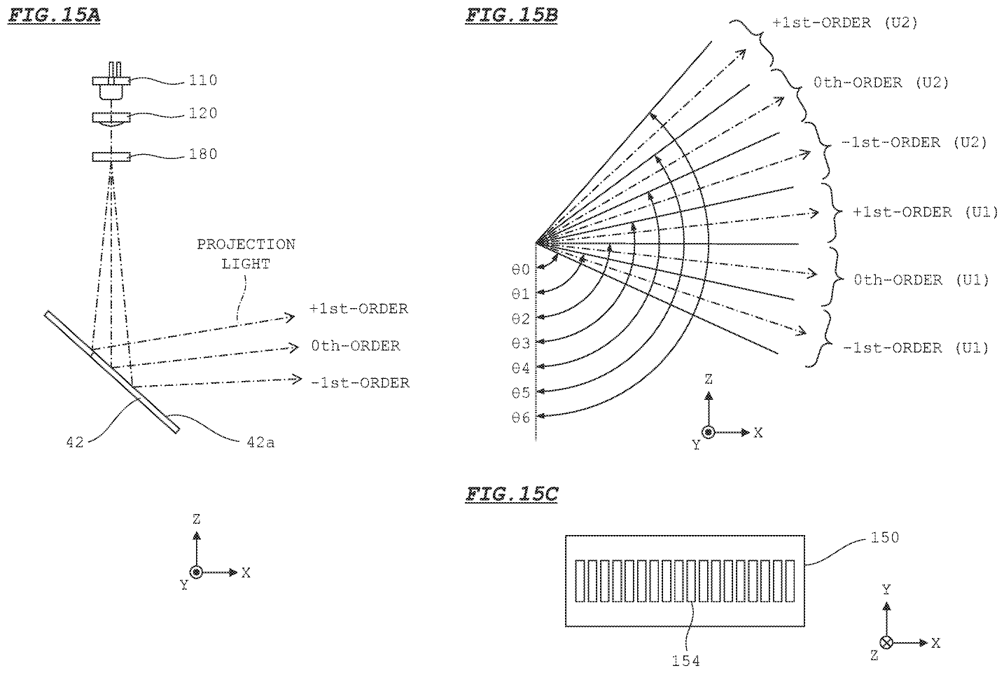

FIG. 15A is a schematic diagram showing a configuration of a projection optical system of the optical unit 40 according to this modification. In FIG. 15A, for convenience, only the optical axis of the projection light is shown.

The optical unit 40 of this modification includes a diffraction grating 180 between the collimator lens 120 and the mirror 42 as compared with the above embodiment. The diffraction grating 180 is installed inside the hole formed in the light blocking member 41c. The diffraction grating 180 is, for example, a step-type diffraction grating, and the diffraction efficiency thereof is adjusted such that the amounts of a 0th-order diffracted light beam, a +1st-order diffracted light beam, and a −1st-order diffracted light beam are substantially equal to each other. The projection light incident on the diffraction grating 180 from the collimator lens 120 is split into a 0th-order diffracted light beam, a +1st-order diffracted light beam, and a −1st-order diffracted light beam in the radial direction about the rotation axis R10 (X-axis direction in FIG. 15A) due to the diffraction action of the diffraction grating 180.

According to this configuration, the projection range of the projection light is expanded in the direction parallel to the rotation axis R10 as compared with the above embodiment. Therefore, in order to obtain the same scanning range as that of the above embodiment, the six optical units 40 do not necessarily have to be disposed, and by adjusting the diffraction angle of the diffraction grating 180, for example, only two optical units 40 may be disposed in the base member 20.

FIG. 15B is a schematic diagram showing a projection state of a total of six diffracted light beams that are generated when two optical units 40 are disposed in this modification, and FIG. 15C is a schematic diagram showing a configuration of the photodetector 150 according to this modification.

When the two optical units 40 installed in this modification are referred to as optical units U1 and U2, the inclination angle of the mirror 42 of the optical unit U1 and the inclination angle of the mirror 42 of the optical unit U2 are different from each other. Therefore, as shown in FIG. 15B, a flux of a +1st-order diffracted light beam, a flux of a 0th-order diffracted light beam, and a flux of a −1st-order diffracted light beam of the optical unit U1, and a flux of a +1st-order diffracted light beam, a flux of a 0th-order diffracted light beam, and a flux of a −1st-order diffracted light beam of the optical unit U2 can be aligned in the Z-axis direction. Therefore, distribution of the fluxes of this modification are substantially the same as that of the above embodiment.

In this modification, three fluxes of the projection light corresponding to the optical unit U1 are projected, and three fluxes of the projection light corresponding to the optical unit U2 are projected. Therefore, the scanning range based on one optical unit is about three times as wide as that of the above embodiment. Therefore, as shown in FIG. 15C, the photodetector 150 of this modification includes 18 sensors 154 in order to achieve the same resolution as that of the above embodiment.

In this modification, by disposing the diffraction grating 180 in each of the optical units U1 and U2, the laser light projected from each of the optical units U1 and U2 can be split in the direction (Z-axis direction) parallel to the rotation axis R10 as described above. Accordingly, the scanning range by one optical unit can be expanded in the direction of the rotation axis R10. Therefore, the number of optical units disposed in the base member 20 can be reduced as compared with the above embodiment, so that the device can be simplified and the cost can be reduced.

According to this modification, the resolution of the photodetector 150 corresponding to the Z-axis direction of each scanning range is the same as that of the above embodiment. In addition, similar to the above embodiment, the length in the Z-axis direction of the entire scanning range is increased.

However, in this modification, since the laser light emitted from each laser light source 110 is split by the diffraction grating 180, the amount of the projection light based on each diffracted light beam is smaller than the amount of the projection light based on one optical unit 40 of the above embodiment. Therefore, in order to increase the detection limit distance, it is necessary to increase the emission power of the laser light source 110 and increase the amount of the projection light based on each diffracted light beam.

In the modification shown in FIG. 15A to FIG. 15C, the number of sensors provided in the photodetector 150 is not limited to 18. For example, one sensor may receive the reflected light based on one diffracted light beam.

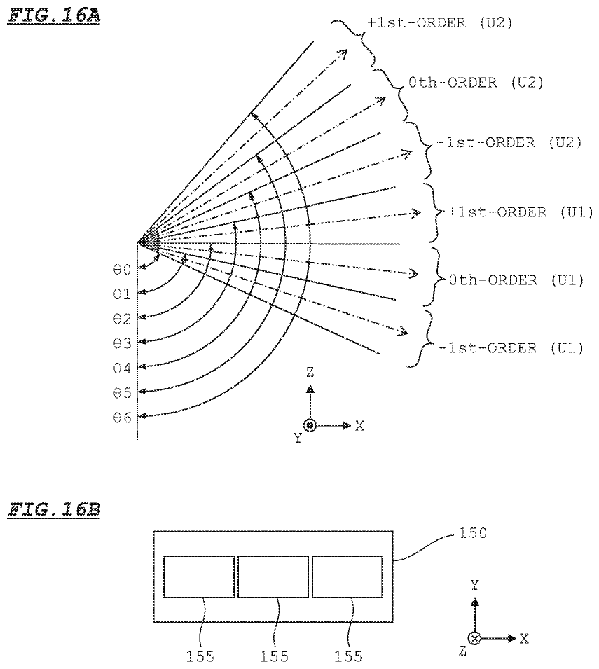

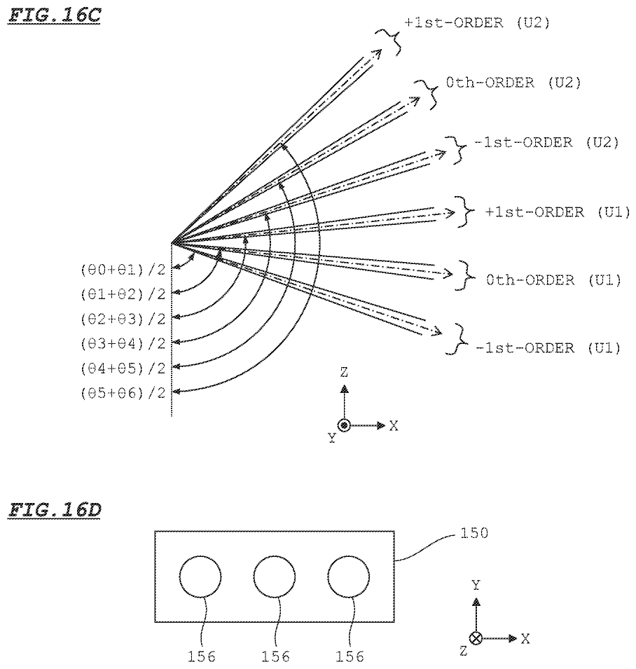

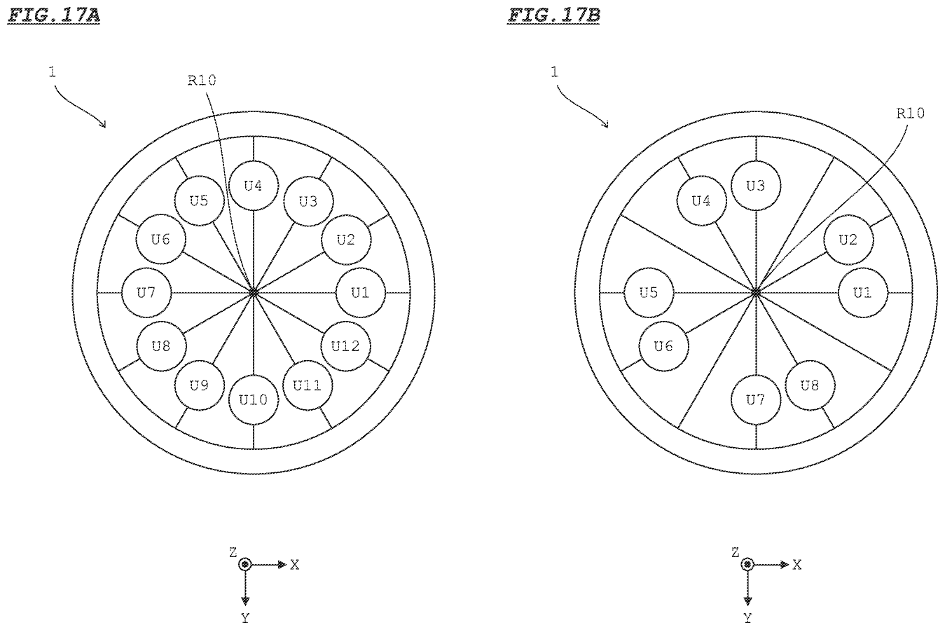

FIG. 16A is a schematic diagram showing six diffracted light beams according to this modification, and FIG. 16B is a schematic diagram showing a configuration of the photodetector 150 according to this modification. In this modification, the diffraction grating 180 is installed in the same manner as the modification shown in FIG. 15A. Accordingly, as shown in FIG. 16A, similar to FIG. 15B, three diffracted light beams based on the optical unit U1 and three diffracted light beams based on the optical unit U2 are projected to the projection region. As shown in FIG. 16B, the photodetector 150 of this modification includes three sensors 155. The reflected light based on one diffracted light beam is incident on each of the three sensors 155.

In the modification shown in FIG. 15A to FIG. 15C, the laser light source 110 is a surface-emitting laser light source having a light emission surface that is longer in one direction, but is not limited thereto, and may be an end face-emitting laser light source.

FIG. 16C is a diagram showing the fluxes L1 to L6 according to this modification. FIG. 16D is a schematic diagram showing a configuration of the photodetector 150 according to this modification. As shown in FIG. 16C, in this modification as well, similar to the modification shown in FIG. 14C, six fluxes of projection light based on the diffracted light beams are projected. In addition, as shown in FIG. 16D, the photodetector 150 of this modification includes three sensors 156 which are substantially circular. The reflected light based on one diffracted light beam is incident on each of the three sensors 156.

In the modification shown in FIG. 15A to FIG. 16D, the diffraction grating 180 is a step-type diffraction grating, but may be a blaze-type diffraction grating. The arrangement position of the diffraction grating 180 may be another position as long as the projection light can be split in the direction of the rotation axis R10 by diffraction. For example, the reflecting surface 42a of the mirror 42 may be replaced with a reflection-type diffraction grating. The number of light beams obtained by splitting with the spectroscopic element does not have to be three.

In the above embodiment, the six optical units 40 are installed along the circumferential direction about the rotation axis R10, but the number of optical units 40 installed is not limited to six, and may be two to five, or may be seven or more.

FIG. 17A is a schematic diagram showing a configuration of the laser radar 1 in which twelve optical units U1 to U12 are installed. The twelve optical units U1 to U12 are arranged at equal intervals (30° intervals) in the circumferential direction about the rotation axis R10. In this case as well, the inclination angles of the installation surfaces 21 of the base member 20 on which the mirrors 42 included in the twelve optical units U1 to U12 are installed are set such that the inclination angles of the twelve mirrors 42 are different from each other. By installing the twelve optical units U1 to U12 as described above, the scanning range in the direction (Z-axis direction) parallel to the rotation axis R10 can be expanded as compared with the above embodiment.

In the above embodiment, a plurality of the optical units 40 are arranged at equal intervals (60° intervals) along the circumferential direction about the rotation axis R10, but do not necessarily have to be installed at equal intervals.

FIG. 17B is a schematic diagram showing a configuration of the laser radar 1 in which eight optical units U1 to U8 are installed. The interval between the optical units U1 and U2, the interval between the optical units U3 and U4, the interval between the optical units U5 and U6, and the interval between the optical units U7 and U8 are 30°. The interval between the optical units U2 and U3, the interval between the optical units U4 and U5, the interval between the optical units U6 and U7, and the interval between the optical units U8 and U1 are 60°. However, in the case where the optical units 40 are not arranged at equal intervals as described above, the plurality of the optical units 40 are preferably installed so as to be point-symmetrical with respect to the rotation axis R10. Accordingly, the rotary part can be rotated in a well-balanced manner in the radial direction about the rotation axis R10.

In the above embodiment, the motor 13 is used as a drive part that rotates the rotary part 60, but instead of the motor 13, a coil and a magnet may be disposed in the fixing part 10 and the rotary part 60, respectively, to rotate the rotary part 60 with respect to the fixing part 10. In addition, a gear may be provided on the outer peripheral surface of the rotary part 60 over the entire circumference, and a gear installed on a drive shaft of a motor installed in the fixing part 10 may be meshed with this gear, whereby the rotary part 60 may be rotated with respect to the fixing part 10.

In the above embodiment, the projection directions of the projection lights projected from the respective optical units 40 are set to directions different from each other, by installing the mirrors 42 of the respective optical units 40 at inclination angles different from each other, but the method for making the projection directions of the projection lights projected from the respective optical units 40 different from each other is not limited thereto.

For example, the mirror 42 may be omitted from each of the six optical units 40, and six structures 41 may be radially installed such that the inclination angles thereof with respect to a plane perpendicular to the rotation axis R10 are different from each other. Alternatively, in the above embodiment, the mirror 42 may be omitted, and instead, the installation surface 21 may be subjected to mirror finish such that the reflectance of the installation surface 21 is increased. Still alternatively, in the above embodiment, each optical unit 40 includes one mirror 42, but may include two or more mirrors. In this case, the angle, with respect to the Z-axis direction, of the projection light reflected by a plurality of mirrors and projected to the scanning region may be adjusted on the basis of the angle of one of the plurality of mirrors.

In the above embodiment, the mirror 42 is used to bend the optical axis of the projection light emitted from the structure 41, but the optical axis of the projection light may be bent by a transmission-type optical element such as a diffraction grating instead of the mirror 42.

It is also possible to apply the structure according to the present invention to a device that does not have a distance measurement function and has only a function to detect whether or not an object exists in the projection direction on the basis of a signal from the photodetector 150. In this case as well, the scanning range in the direction (Z-axis direction) parallel to the rotation axis R10 can be expanded.

The configuration of the optical system of each optical unit 40 is not limited to the configuration shown in the above embodiment. For example, the opening 131 may be omitted from the condensing lens 130, and the projection optical system and the light-receiving optical system may be separated from each other such that the optical axis A1 of the projection optical system does not extend through the condensing lens 130. Furthermore, the number of laser light sources 110 disposed in the optical unit 40 is not limited to one, and may be plural. In this case, projection light may be generated by integrating the laser light emitted from each laser light source 110 with a polarization beam splitter or the like. This configuration is suitable, for example, for use in the modification in FIG. 15A.

In the above embodiment, in order to expand the scanning range in the direction parallel to the rotation axis, the projection directions of the projection lights projected from the plurality of the optical units 40 are made different from each other in the direction (Z-axis direction) parallel to the rotation axis R10. However, for other purposes, the projection directions of the projection lights projected from the plurality of the optical units 40 may be set to be the same in the direction (Z-axis direction) parallel to the rotation axis R10.

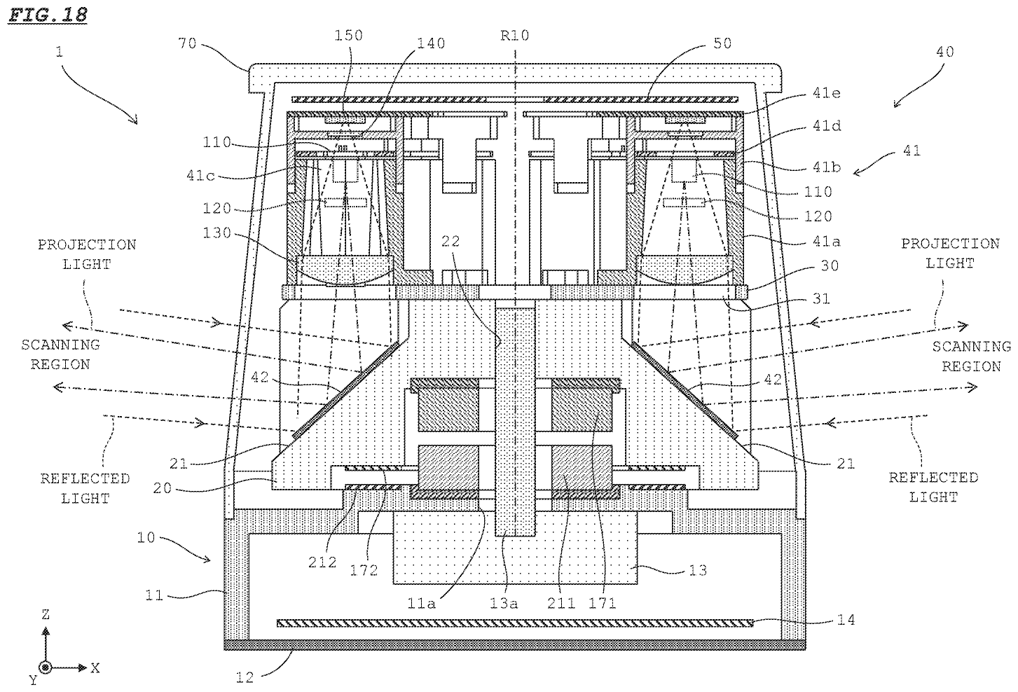

FIG. 18 is a cross-sectional view showing a configuration of the laser radar 1 according to this modification. In this modification, the inclination angle, with respect to a horizontal plane (X-Y plane), of the installation surface 21 on the X-axis positive side of the rotation axis R10 and the inclination angle, with respect to the horizontal plane, of the installation surface 21 on the X-axis negative side of the rotation axis R10 are equal to each other, so that the inclination angles of the two mirrors 42 installed on these installation surfaces 21 are also equal to each other. Similarly, the inclination angles of the other installation surfaces 21 are set to the same angle as those of the above two installation surfaces 21, so that the inclination angles of the other mirrors 42 are also set to the same angle as those of the above two mirrors 42. Accordingly, the projection directions of the projection lights projected from the six optical units 40 are the same in the direction parallel to the rotation axis R10. When the projection directions of all the optical units 40 are set to be the same in the direction parallel to the rotation axis R10 as described above, the detection frequency for the range around the rotation axis R10 can be increased, and accordingly, a high frame rate can be achieved without increasing the rotation speed.

In addition to the above, various modifications can be made as appropriate to the embodiments of the present invention, without departing from the scope of the technological idea defined by the claims.

What is claimed is:

1. A laser radar comprising:
a base member;
a drive part configured to rotate the base member about a rotation axis; and
a plurality of optical units arranged on the base member at a predetermined interval in a circumferential direction about the rotation axis and each configured to project laser light in a direction away from the rotation axis, wherein
projection directions of the laser lights from the plurality of optical units are different from each other in a direction parallel to the rotation axis.

2. The laser radar according to claim 1, wherein
each of the optical units includes
a laser light source, and
an optical element configured to bend an optical axis of the laser light source, and
the projection directions of the laser lights from the plurality of optical units are different from each other in the direction parallel to the rotation axis by changing a bending angle of the optical axis by the optical element for each of the optical units such that the bending angles of the optical axes by the optical elements of the optical units are different from each other.

3. The laser radar according to claim 2, wherein the optical element is a mirror.

4. The laser radar according to claim 3, wherein
a plurality of installation surfaces for installing the mirrors are formed in the base member in installation regions of the plurality of optical units, respectively, and
inclination angles of the plurality of installation surfaces with respect to a plane perpendicular to the optical axis are different for each of the installation regions of the optical units.

5. The laser radar according to claim 2, wherein
the laser light source is a surface-emitting laser light source having a light emission surface that is longer in one direction,
each of the optical units includes a collimator lens on which the laser light emitted from the laser light source is incident, and
the laser light source of each of the optical units is installed such that a longitudinal direction of the light emission surface coincides with the direction parallel to the rotation axis when the laser light is projected.

6. The laser radar according to claim 2, wherein each of the optical units includes a spectroscopic element configured to split the laser light emitted from the laser light source, in a direction corresponding to the direction parallel to the rotation axis.

7. The laser radar according to claim 2, wherein each of the optical units includes
a photodetector configured to receive reflected light which is the projected laser light reflected by an object, and
a condensing lens configured to condense the reflected light onto the photodetector.

8. The laser radar according to claim 7, wherein the photodetector includes a plurality of sensors separated from each other in a direction corresponding to the direction parallel to the rotation axis.

9. The laser radar according to claim 7, wherein
in each of the optical units, an optical axis of a projection optical system for projecting the laser light and an optical axis of a light-receiving optical system for receiving the reflected light are parallel to each other, and
an opening through which the optical axis of the projection optical system passes is provided in the condensing lens.

10. The laser radar according to claim 9, wherein
each of the optical units includes a light blocking member covering an area round the optical axis of the projection optical system, and
the light blocking member is fitted into the opening.

11. The laser radar according to claim 9, wherein
the optical axis of the projection optical system and the optical axis of the light-receiving optical system are aligned in the circumferential direction about the rotation axis, and
the optical axis of the light-receiving optical system is located at a position on a rear side in a rotation direction of the base member with respect to the optical axis of the projection optical system.

12. The laser radar according to claim 1, wherein
the plurality of optical units project the laser lights at times different from each other, and
an installation position of each of the optical units with respect to the base member is set to a position displaced from an equal angle position in the circumferential direction by a predetermined angle, such that each of the optical units projects the laser light at the equal angle position in the circumferential direction.

13. A laser radar comprising:
a base member;
a drive part configured to rotate the base member about a rotation axis; and
a plurality of optical units arranged on the base member at a predetermined interval in a circumferential direction about the rotation axis and each configured to project laser light in a direction away from the rotation axis, wherein
projection directions of the laser lights from the plurality of optical units are the same in a direction parallel to the rotation axis.
